(19) United States
(12) Patent Application Publication
(10) Pub. No.: US 2023/0192373 A1
(43) Pub. Date: Jun. 22, 2023

(54) PLASTIC CONTAINER

(71) Applicant: ALPLA WERKE ALWIN LEHNER GMBH & CO. KG, Hard (AT)

(72) Inventors: Thomas Bohle, Alberschwende (AT); Christian Zmölnig, Schwarzach (AT); Daniel Schnetzer, Altach (AT)

(21) Appl. No.: 17/999,206

(22) PCT Filed: May 18, 2021
(86) PCT No.: PCT/EP2021/063123

§ 371 Date: Nov. 17, 2022

(30) Foreign Application Priority Data
May 18, 2020 (CH) 00598/20

(51) Int. Cl. B65D 55/16; B65D 1/02; B65D 39/08; B65D 39/16; B65D 47/10; B65D 1/09; B65D 35/42

(52) U.S. Cl. CPC B65D 55/16; B65D 1/0238; B65D 39/08; B65D 39/16; B65D 47/10; B65D 1/095; B65D 35/42; B65D 2501/0009

(57) ABSTRACT

The invention relates to a plastic container that is blown in a blow mold, having a body, defining an opening is provided, and a disposable closure, which closes the opening and is formed in the blow mold together with the body. A holding strip with a first end and a second end is also formed in the blow mold together with the body and the disposable closure. The first end is permanently fixed to the body, and the second end is permanently fixed to the closure. The body, the disposable closure, and the holding strip are formed as a single piece.

### CROSS-REFERENCE TO RELATED APPLICATIONS

This application is a national phase entry under 37 U.S.C § 371 of PCT/EP2021/063123 filed May 18, 2021, which claims priority to Swiss Patent Application No. 00598/20 filed May 18, 2020, the entirety of each of which is incorporated by this reference.

### FIELD OF THE INVENTION

The invention relates to a plastic container, which is blown in a blow mold.

### PRIOR ART

Disposable closures formed in one piece together with the containers they close are known from the prior art in the field of plastic closures. Such a closure is provided primarily for products which are removed from the container all at once. The empty container is then necessarily disposed of separately from the twisted-off closure.

For environmental protection reasons, such closures are undesirable since it is not ensured that the closure and the empty container are disposed of together.

Such containers together with closures are cost-effective to produce, but re-closing of the container after the closure has been twisted off is not possible for design-related reasons.

### Advantages of the Invention

An advantage of the invention is a closure which can be twisted off and must be disposed of together with the container it closed.

### SUMMARY OF THE INVENTION

The advantages are achieved by the subject-matter of the independent claim. Developments and/or advantageous alternative embodiments form the subject-matter of the dependent claims.

According to a first exemplary embodiment, a plastic container which is blown in a blow mold has a body in which an opening is provided, and a disposable closure which closes the opening and has been formed together with the body in the blow mold. In the blow mold, a holding strip with a first and a second end has been formed together with the body and the disposable closure, wherein the first end is permanently connected to the body and the second end is permanently connected to the disposable closure. The body, the disposable closure and the holding strip are formed as a single piece.

By forming the holding strip, the disposable closure, which is twisted off with either a left-hand or a right-hand rotation, remains connected to the container in the twisted-off state. The disposable closure is captively held on the body and, since it consists of the same material as the body, is particularly easily fed together with the latter into a reusable material cycle and recycled. The opening for removing the product from the container may also be arranged in a tubular section or neck which is formed from the body. The tubular section or neck is preferably generally connected as a single piece to the remaining container body via a container shoulder. The holding strip can be permanently connected to the tubular section, or the neck, and/or to the container shoulder.

In a particular embodiment, the disposable closure is a rotary knob closure. The latter is particularly easy to form in the blow mold together with the body and is moreover easy to use. In the context of this application, a rotary knob closure is to be understood as a disposable closure that can be rotated clockwise or counterclockwise, completely breaking the plastic bordering the opening in the process and thereby uncovering the opening for removing the product from the body. A disposable closure which is broken off the body by bending would also be conceivable.

In another embodiment, the holding strip consists of the same material as the disposable closure and the body. The single-type material of the entire container enables particularly easy recycling.

It has proven expedient if the rotary knob closure has a cap section which is connected in one piece to the section bordering the opening and at the connection has a weakened region designed as a first predetermined breaking point. A gripping section projects from the cap section. The cap section thus tears away from the opening at a predefined location and for the removal of the product uncovers said opening.

In a further embodiment of the invention, the gripping section has an upper edge, a lower edge and a first and a second lateral edge, wherein the lateral edges space the upper and the lower edge apart from one another. As a result, a substantially rectangular gripping section is formed with two turning wings. The user can grip these turning wings well and apply a torque via them to the cap section, whereby the latter is twisted off the body. In a special form, the gripping section is rectangular.

According to a further exemplary embodiment, the first end of the holding strip is connected directly to the body below the lower edge. In combination with the embodiment that the second end is connected to the rotary knob closure at the upper edge, a holding strip is formed with a sufficient length so that it does not interfere with the twisting of the closure. In particular, the holding strip is sufficiently long so that the closure can be turned such that the upper edge is oriented toward the opening.

The holding strip expediently extends along one of the lateral edges. As a result, it is formed in one plane with the gripping section and can be spaced apart from the gripping section during the twisting without hindering the opening process.

In a further embodiment, the holding strip is connected to one of the lateral edges by a second predetermined breaking point. As a result, no separation between the holding strip and the gripping section needs to be provided during the molding of the holding strip in the blow mold. This has the advantage that the blow mold can be constructed more easily and accordingly more cost-effectively. Provided as a second predetermined breaking point between the holding strip and the gripping section is a thin plastic film, which tears during the twisting as a result of a low applied force.

In a further embodiment, from one of the edges that is free from the holding strip there projects a closure element, which is formed in one piece with the rotary knob closure, consists of the same material as the remaining container elements and is designed in such a way that the opening can be closed with this closure element. This closure element, which in one exemplary embodiment may be opposite the cap section, results in the disposable closure becoming a closure with which the opening can be re-closed several times. Moreover, the closure element together with the other elements is formed in the blow mold in one piece. This reclosing function by the closure element as a result of the provision of the holding strip is particularly sensible since the disposable closure and thus the closure element cannot be lost when the opening is open, and is ready to be gripped at any time when the opening is to be closed. Consequently, the holding strip and the closure element interact directly.

The closure element is expediently a stopper which can be held in a force-fitting, frictional and/or form-fitting manner on the section bordering the opening. As a result, the stopper is held securely in the opening and can be pulled out of the latter at any time. For a frictional or force-fitting hold, the sealing region of the stopper can have a slightly larger outer diameter than the inner diameter of the opening. Since the plastic of the stopper and of the section bordering the opening can be flexible, a force fit or friction fit is produced when the stopper is pressed into the opening. A form fit may be realized, for example, by engaging a groove oriented in the circumferential direction of the stopper in the edge of the opening.

In a further embodiment, a tubular section which is formed within the gripping section extends between the cap section and the closure element. On the one hand, the tubular section increases the contact surface of the fingers during opening in order to enable application of sufficient torque to shear off or break the first predetermined breaking point. On the other hand, the section serves as an actuator when the stopper is being inserted into the opening. In addition, the stopper is held firmly on the upper side of the gripping section by the tubular section and cannot break off of the gripping section under load.

The outer diameter of the tubular section is advantageously greater than the thickness of the gripping section. The stopper is the extension of the tubular section and is thereby held stably on the upper side of the gripping section. When the stopper is being pressed into the opening, the stopper can therefore not break off from the gripping section.

In a further embodiment, the stopper is hollow. The tubular section can serve to guide blowing air into the stopper in order to blow out the latter in such a way that its outer wall rests completely against the inside of the blow mold during manufacture and does not have any indentations after removal from the blow mold. It can thus be ensured that the stopper can close the opening of the container in a sealing manner after the container has been opened.

The plastic container is expediently produced from polyolefins suitable for blow molding, such as polypropylene and polyethylene and the derivatives thereof, and recycling materials, PET, recycled PET and bio-based plastics, for example bio-based polybutylene succinates. As a result, each plastic container produced in a blow mold, in particular in extrusion blow molding, can be equipped with a closure described above, in that the blow mold is formed accordingly in order to form the closure.

According to a further exemplary embodiment, the container is manufactured in an extrusion blow molding process. In this case, the disposable closure and the holding strip are formed from the flash that is produced in the blow mold during extrusion blow molding. As a result, on the one hand, the disposable closure and the holding strip can be formed in a simplified manner by closing the blow mold, and the production of the disposable closure and of the holding strip is associated with particularly little material outlay on the other hand. This in particular because the flash is inevitably produced in the blow mold.

Although extrusion blow molding is a method for producing plastic containers, this method forms structural features which are visible on a hollow blow body produced by means of this method. Since the hollow blow body is produced from a predetermined section of a tube, which is clamped at its open ends during the closing of the blow mold halves, the tube is welded together at these two ends by compression. The tube portions compressed by the closed blow mold halves, called flashes, are mechanically removed from the hollow blow body after the hollow blow body has been demolded. This weld seam can be seen on the hollow blow body. The weld seam additionally forms a burr, which differs from a mold separation of, for example, injected objects since it is rough on its upper side. Typically, weld seams are visible in the bottom region and shoulder/neck region of hollow blow bodies. In the case of tubes which do not have a bottom, the weld seams are in the region of the shoulder/neck region. In the proposed plastic container, the weld seam extends circumferentially around the closure, or around the gripping section, and lies in the parting plane of the blow mold.

According to a further exemplary embodiment, the plastic container is produced by means of injection blow molding. In this case, the closure can be designed as an injection part and the body accommodating the later product can be manufactured by blow molding.

### BRIEF DESCRIPTION OF THE DRAWINGS

Further advantages and features become apparent from the following description of an exemplary embodiment of the invention with reference to the schematic representations. Shown, in a representation not true to scale, are:

FIG. 1: a first embodiment of a plastic container in the form of a semi-finished product in a side view;

FIG. 2: the embodiment of FIG. 1 in an axonometric view;

FIG. 3: a second embodiment of the plastic container in the form of a tube in a side view;

FIG. 4: a detailed view of a disposable closure, in which its gripping section is not shown for reasons of clarity;

FIG. 5: an axonometric view of a third embodiment of the plastic container in the form of a bag;

FIG. 6: a fourth embodiment of a plastic container in the form of a canister, and

FIG. 7: a side view of a fifth embodiment which shows a disposable closure without a closure element.

### DETAILED DESCRIPTION

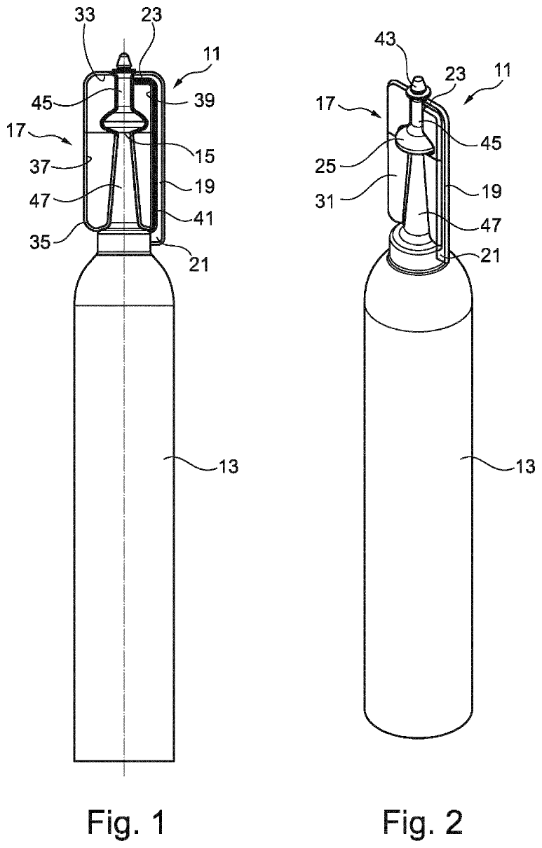

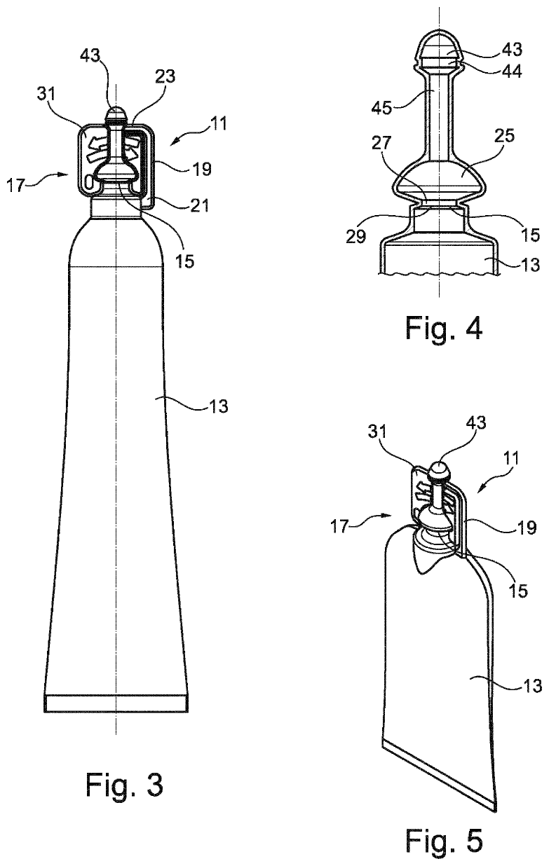

FIGS. 1, 2, 3, 4 and 6 show various embodiments of a plastic container, which is denoted as a whole by reference sign 11. The plastic container 11 is blown in a blow mold. The container 11 has a body 13 on which an opening 15 is provided. A disposable closure in the form of a rotary knob closure 17 closes the opening 15. The rotary knob closure has been formed together with the body 13. As a result, the closure 17 can be twisted off the body and the opening 15 is uncovered.

Together with the body 13 and the closure 17, a holding strip 19 has also been formed in one piece in the blow mold. The holding strip 19 has a first end 21 and a second end 23. At the first end 21, the holding strip 19 is fastened to the body 13. At the second end 23, the holding strip 19 is fastened to the rotary knob closure 17. As a result, the rotary knob closure 17 is captively held on the body, even when the rotary knob closure 17 has been twisted off the body 13 in order to open the container 11. In that the body 13, the rotary knob closure 17 and the holding strip 19 are formed together in the blow mold, thus they consist of the same material. In the present exemplary embodiment, the plastic container 11 is manufactured by extrusion blow molding so that the closure 17 and the holding strip 19 are formed from the flash produced when the blow mold is closed.

The rotary knob closure 17 has a cap section 25 which is connected in one piece to the section 29 bordering the opening 15, as can be seen better in FIG. 4, and at the connection has a weakened region designed as a first predetermined breaking point 27. A gripping section 31 projects from the cap section 25. The gripping section 31 has an upper edge 33, a lower edge 35 and a first and second lateral edge 37, 39. The lateral edges 37, 39 space the upper and lower edges 33, 35 apart from one another. As a result, the gripping section 31 acquires a substantially rectangular shape.

The first end 21 is connected directly to the body below the lower edge 35. The second end 23 is connected to the rotary knob closure 17 at the upper edge 33. In addition, the holding strip 19 extends along one of the lateral edges 37, 39. As a result, after opening, the holding strip 19 has a sufficient length so that the closure 17 is not in the way during emptying of the product filling the container 11. Since the gripping section 31 and the holding strip 19 are formed from the flash which is inevitably produced during the blow molding, it is advantageous for simplified production if a second predetermined breaking point 41 is present between the holding strip 19 and the gripping section 31. This second predetermined breaking point can be realized in the form of a plastic film which tears when the rotary knob closure 17 is turned.

A closure element in the form of a stopper 43, which is formed in one piece with the rotary knob closure 17 and consists of the same material as the remaining container elements, projects from the upper edge 33. After the rotary knob closure 17 has been twisted off, the gripping section 31 can be turned so that the stopper 43 can be inserted into the opening 15 in order to re-close it. For simplified use, the stopper 43 can be rounded at its open end. In this case, the stopper 43 is held in a force-fitting, frictional and/or form-fitting manner on the section 29 bordering the opening 15. As a result, the opening 15 can be closed at least in a dust-tight manner. For example, a groove 44 which can be engaged in the section 29 may also be formed on the stopper 43. The length of the holding strip 19, which is produced by being led along a lateral edge 37, 39 makes it possible for the turning of the stopper 43 in the direction of the opening 15 not to be hindered. The holding strip 19 is therefore sufficiently long for the re-closure process to be possible.

A tubular section 45, which is formed within the gripping section 31, extends between the cap section 25 and the stopper 43. The outer diameter of the tubular section 45 is greater than the thickness of the gripping section 31. The tubular section 45 increases the contact surface of the fingers during opening in order to enable application of sufficient torque to shear off or break the first predetermined breaking point 27. On the other hand, the tubular section 45 serves as an actuator when the stopper 43 is being inserted into the opening 29. The tubular section 45 also makes it possible for blowing air to reach the stopper 43 during the production of the plastic container 11 in order to make it hollow.

FIGS. 1 and 2 show an embodiment variant in which the opening 29 is provided at the end of a tapering extension 47. The extension 47 makes it particularly easy to pour the container contents into a further container. As a result of the extension 47, the production of a 2-component mixture in the further container is possible without spillage of the container contents. Furthermore, FIGS. 1 and 2 show that the container 11 can be a semi-finished product. The latter is filled with a product at the open end and the container is converted to a tube at the open end by welding.

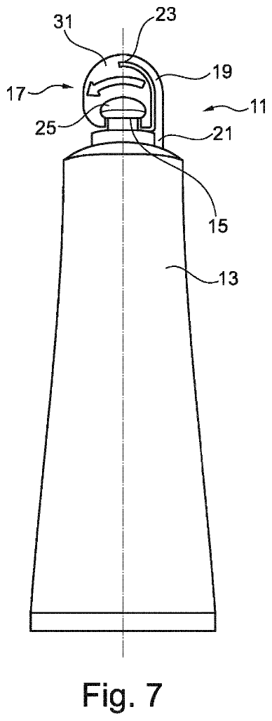

FIG. 7 shows a tube 11 with a disposable closure, which is free of a closure element 43. In this embodiment, the second end 23 of the holding strip 19 can extend as far as the center of the upper edge 33.

A maximum length of the holding strip 19 is achieved by the holding strip extending along all free edges 33, 35, 37, 39. As a result, the length of the holding strip 19 that enables particularly simple operation of the disposable closure and all additional functions, such as the re-closure, can be realized by the design of the blow mold.

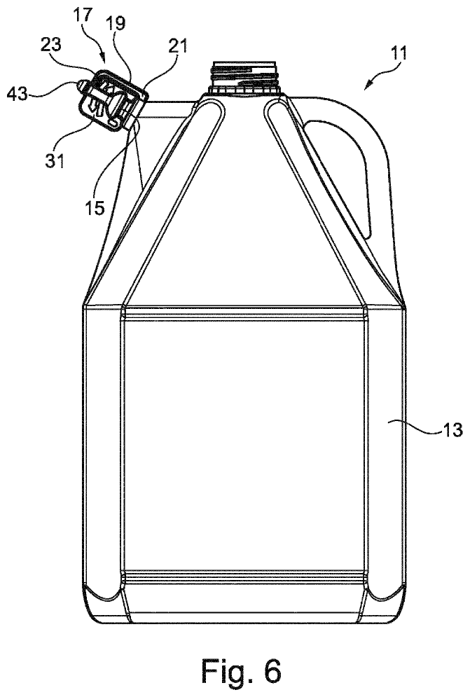

As the figures show, the plastic container 11 can be a tube, a tube in the form of a bag or a canister. This enumeration is exemplary and therefore not exhaustive. In the case of the canister, as shown in FIG. 6, the rotary knob closure 17 serves to close a vent opening 15.

1. Plastic container which is blown in a blow mold, comprising
a body defining an opening,
a disposable closure configured to close the opening and formed together with the body in the blow mold,
a holding strip with a first and a second end formed together with the body and the disposable closure in the blow mold, wherein the first end is permanently connected to the body and the second end is permanently connected to the closure, wherein the body, the disposable closure and the holding strip are in one piece.

2. Plastic container according to claim 1, wherein the disposable closure is a rotary knob closure.

3. Plastic container according to claim 1, wherein the holding strip consists of the same material as the disposable closure and the body.

4. Plastic container according to claim 2, wherein the rotary knob closure has a cap section which is connected in one piece to a section bordering the opening and at a connection thereof has a weakened region configured as a first predetermined breaking point, wherein a gripping section projects from the cap section.

5. Plastic container according to claim 4, wherein the gripping section has an upper edge, a lower edge and a first and a second lateral edge, wherein the first and second lateral edges space the upper and the lower edges apart from one another.

6. Plastic container according to claim 5, wherein the first end of the holding strip is connected directly to the body below the lower edge.

7. Plastic container according to claim 5, wherein the second end is connected to the rotary knob closure at the upper edge.

8. Plastic container according to claim 5, wherein the holding strip extends along one of the lateral edges.

9. Plastic container according to claim 5, wherein the holding strip is connected to one of the lateral edges by a second predetermined breaking point.

10. Plastic container according to claim 5, further comprising a closure element, which is formed in one piece with the rotary knob closure, consists of the same material as the remaining container elements and is configured in such a way that the opening can be closed with the closure element, projects from one of the upper or lower edges that is free from the holding strip.

11. Plastic container according to claim 10, characterized in that wherein the closure element is a stopper which can be held in a force-fitting, frictional and/or form-fitting manner on the section bordering the opening.

12. Plastic container according to claim 11, wherein the stopper is hollow.

13. Plastic container according to claim 4, further comprising a tubular section formed within the gripping section and extends between the cap section and the closure element.

14. Plastic container according to claim 13, wherein an outer diameter of the tubular section is greater than a thickness of the gripping section.

15. Plastic container according to claim 1, wherein the plastic container is produced from polyolefins suitable for blow molding, comprising the group consisting of at least one of polypropylene, polyethylene and derivatives thereof, and recycling materials, PET, recycled PET, bio-based plastics, and/or bio-based polybutylene succinates.

16. Plastic container according to claim 1, wherein the plastic container is manufactured in an extrusion blow molding process and the disposable closure and the holding strip are formed from a flash that is produced in the blow mold.
